(19) United States
(12) Patent Application Publication
(10) Pub. No.: US 2025/0335952 A1
(43) Pub. Date: Oct. 30, 2025

(54) TECHNIQUES FOR AUTOMATING PROCESSES

(71) Applicant: Stevens Ventures LLC, Milford, CT (US)

(72) Inventors: Nathaniel STEVENS, Milford, CT (US); Panayiotis STAVRINIDES, Nicosia (CY)

(21) Appl. No.: 19/193,003

(22) Filed: Apr. 29, 2025

Related U.S. Application Data
(60) Provisional application No. 63/640,038, filed on Apr. 29, 2024.

(51) Int. Cl. G06Q 30/0217; G06Q 30/0207; G06Q 30/0234; G06Q 30/0238

(52) U.S. Cl. CPC G06Q 30/0217; G06Q 30/0222; G06Q 30/0234; G06Q 30/0238

(57) ABSTRACT

The present disclosure generally relates to techniques for automating processes.

### CROSS-REFERENCE TO RELATED APPLICATIONS

The present application claims priority to U.S. Provisional Patent Application Ser. No. 63/640,038, entitled “TECHNIQUES FOR AUTOMATING PROCESSES” filed Apr. 29, 2024, which is hereby incorporated by reference in its entirety for all purposes.

### BACKGROUND

Businesses often employ digital payment systems as a way to accept payments for their goods and services, rather than more traditional methods like cash or check tender. The business development landscape has also substantially evolved, leveraging tools such as advertising, public relations, and, more recently, online reviews to promote their products and/or services. With the advent and surge in popularity of the Internet, online reviews have become a vital tool for gaining exposure and acquiring new customers via the World Wide Web (WWW). In fact, millions of consumers now rely on reviews and ratings to guide their purchasing decisions. Methods of enhancing review visibility to advertise one's business on the WWW include creating a business listing on search engines and online directories and encouraging reviews.

Digital payment acceptance typically requires a point-of-sale system or credit card terminal for retail, brick-and-mortar businesses, or an online store for e-commerce merchants. Behind these interfaces, a payment gateway computer or authorization switch collects unique consumer account data and requests authorization via a card network such as Visa or MasterCard, a cryptocurrency exchange, or another digital wallet. Non-real-time authorization is also possible, for instance, via ACH payment, where authorizations are provided up to 2 times per day.

Post-purchase, many businesses encourage consumers to share and comment on their experience via the WWW to amplify their credibility and digital reach. Some businesses also encourage more discrete and direct communication to swiftly handle disgruntled customers, preventing potential harm to their visibility on search engines and online directories. To facilitate such behavior, merchants solicit reviews and referrals in numerous ways, including providing a QR code for scanning with smartphones, and leading customers to a URL containing the business online listing or review form. Alternatively, merchants may send a unique resource locator via text message or email to solicit reviews.

Payment systems typically authorize transactions in real-time to ensure good funds are available prior to the merchant trading their goods and services. While authorizations are continuous, funds transfers usually occur only once a transaction closes and settlement happens at night. However, the settlement of cryptocurrency transactions can occur in real time.

Processing systems and gateways will generally encrypt sensitive cardholder or account holder data and store them on their servers. This approach facilitates customer convenience when an authorization requires extending or increasing, a common scenario in industries such as travel, hotel, and car rentals, or if a return needs processing back to the account. Returns prior to settlement are deemed reversals, while those post-settlement are considered refunds. Returns can be for any amount, typically capped to the initial purchase amount as a measure of compliance and security. So long as the payment system retains the account information, the consumer will not need to provide their account details again.

Customers often receive rewards, points, or cash back from card issues when using credit or debit cards, incentivizing their use. However, merchants must pay a fee to accept such cards, part of which covers interchange to the consumer's issuing bank, and the remainder covers the discount rate to the merchant's acquiring bank for mitigating transaction-related risk. The combined fee is typically 2-4% of the total transaction amount. For illustrative purposes, assuming the total fee is 3% and a $100 transaction is consummated, the merchant will net $97.00, with some portion of the $3.00 being split between the issuing bank and the merchant acquiring side.

Historically, businesses have not directly incentivized the debit or credit card used for transactions. The lack of such incentives potentially discourages customers from leaving reviews, resulting in a deficient and potentially biased pool of feedback. Addressing these concerns and automating the review solicitation processes can lead to a more balanced and accurate portrayal of customer opinion, guiding businesses to deliver quality products and services better aligned with customer expectations.

### SUMMARY

Current techniques for incentivizing post-sale actions are generally ineffective and/or inefficient. For example, some techniques require merchants to manually provide incentives through communication with and/or from a customer, including the customer mailing in a rebate to a merchant. Such techniques can be cumbersome and slow. This disclosure provides more effective and/or efficient techniques for incentivizing post-sale actions. Some techniques optionally complement or replace other techniques related to transactions.

Some techniques are described herein for providing an automated rebate program with post-sales incentives intrinsically linked to customer reviews. Once a customer leaves a review, a system recognizes this action and provides a corresponding rebate connected directly to their transaction. This effectively incentivizes customers to ensure that a wider spectrum of customers are prompted to provide their experience and feedback, balancing the somewhat polarizing nature of online reviews. Moreover, it aids effective business decision-making by yielding invaluable, honest insights. In some embodiments, a rebate system connected to a payment system solicits a post-sale action from the customer via one or more solicitation methods. The customer is incentivized to take the post-sale action via a rebate program. The rebate system verifies that the post-sale action was taken, or the merchant manually updates the rebate system that the action was indeed taken (e.g., offline verification), within a predetermined period of time. A full or partial reversal/refund is initiated via the payment system for the amount specified by the rebate program.

In some embodiments, a method that is performed at a computer system is described. In some embodiments, the method comprises: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

In some embodiments, a non-transitory computer-readable storage medium storing one or more programs configured to be executed by one or more processors of a computer system is described. In some embodiments, the one or more programs includes instructions for: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

In some embodiments, a transitory computer-readable storage medium storing one or more programs configured to be executed by one or more processors of a computer system is described. In some embodiments, the one or more programs includes instructions for: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

In some embodiments, a computer system is described. In some embodiments, the computer system comprises one or more processors and memory storing one or more programs configured to be executed by the one or more processors. In some embodiments, the one or more programs includes instructions for: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

In some embodiments, a computer system is described. In some embodiments, the computer system comprises means for performing each of the following steps: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

In some embodiments, a computer program product is described. In some embodiments, the computer program product comprises one or more programs configured to be executed by one or more processors of a computer system. In some embodiments, the one or more programs include instructions for: receiving an indication of a first review corresponding to a first transaction; and after receiving the indication of the first review corresponding to the first transaction: in accordance with a determination that the first review satisfies a first set of one or more criteria, providing, to an account corresponding to the first transaction, a first amount of value; and in accordance with a determination that the first review does not satisfy the first set of one or more criteria, forgoing providing, to the account corresponding to the first transaction, the first amount of value.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram of a system provided for implementing a post-sale action incentives program in accordance with some embodiments.

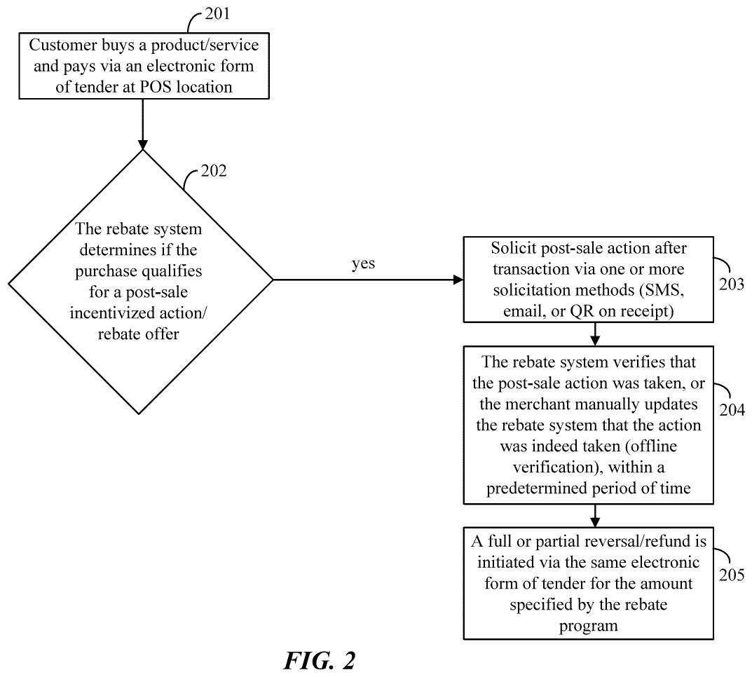

FIG. 3 is a flow diagram illustrating an exemplary rebate redemption process in accordance with some embodiments.

FIG. 4 shows a screenshot from an example of a user interface where a merchant can enter a percentage of the sale transaction that would be returned to a customer as a rebate in accordance with some embodiments.

FIG. 5 is an example of a landing page which presents to a user one or more post-sale actions and their corresponding rebate incentives in accordance with some embodiments.

FIG. 6 is an example of an electronic receipt in accordance with some embodiments.

FIG. 7 is an example of a review request in accordance with some embodiments.

FIG. 8 is an example of a response to a positive review in accordance with some embodiments.

FIG. 9 is an example of a response to a negative review in accordance with some embodiments.

FIG. 10 is a flow diagram illustrating a method for incentivizing post-sale actions in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a second subsystem device or a subsystem device could be termed a first subsystem device, without departing from the scope of the various described embodiments. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

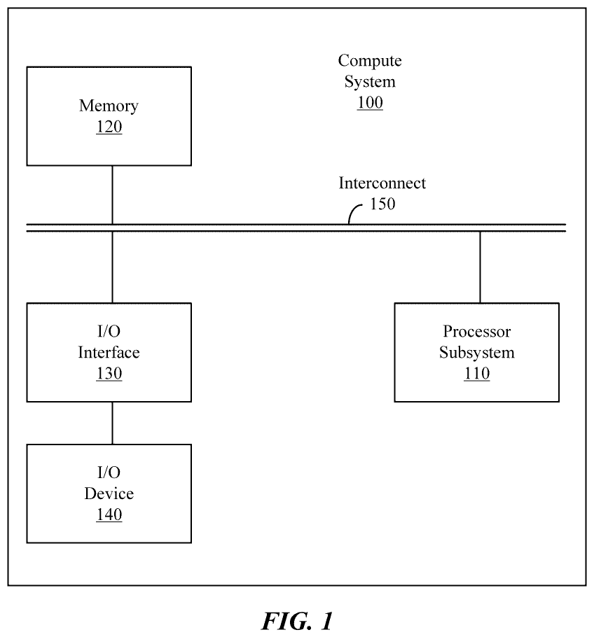

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some examples, I/O interface 130 is included with I/O device 140 such that the two are a single component. It should be recognized that there can be one or more I/O interfaces, with each I/O interface communicating with one or more I/O devices. In some examples, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

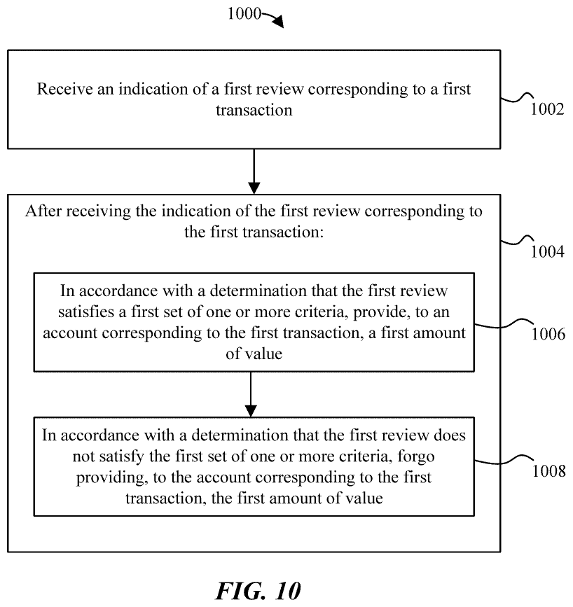

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with method 1000 (FIG. 10) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to communicate with other devices. In some examples, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is communicating with a network via a network interface device (e.g., configured to communicate over Wi-Fi, Bluetooth, Ethernet, or the like). In some examples, compute system 100 is directly or wired to the network.

Attention is now directed towards techniques for incentivizing post-sale actions, such as reviews, referrals, reposts, mentions, and/or surveys. Some techniques optionally complement or replace other techniques related to transactions.

When a customer buys a product or a service at POS location 300, the customer often pays via an electronic form of tender. Examples pf electronic forms of tender include Credit/Debit Card, ACH/eCheck, Cryptocurrency, Digital wallet, and/or Wire. In some embodiments, Credit/Debit Card tender types can be transmitted via a number of transmission mechanisms including Card present and not Card Present (“keyed-in”) transactions. In some embodiments, POS location 300 refers to “points of transaction” such as a physical point of sale (where a Credit/Debit card may be present) and internet websites where customers shop online and enter their payment account information (Card not present/“keyed-in” transactions), and mail order or telephone merchants who receive their payment account information by telephone and/or email (MOTO) or by any other electronic means.

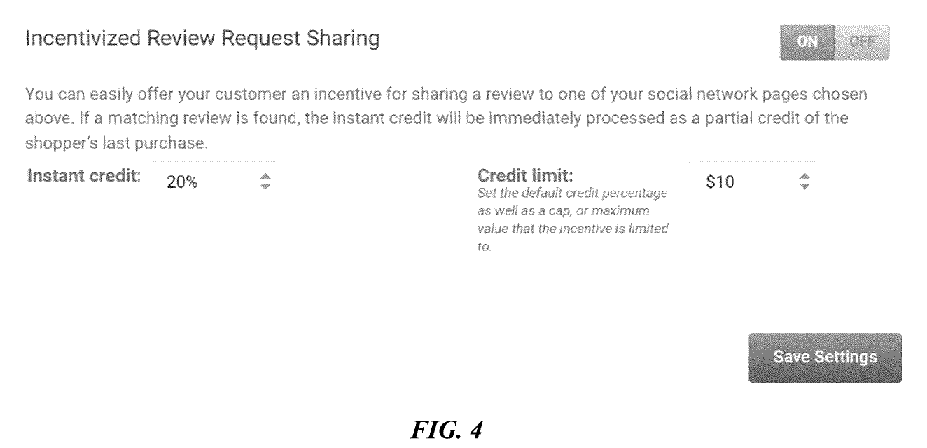

In some embodiments, a rebate program can be configured by a merchant via a private web user interface (UI) via 302 hosted on web server 301. In some embodiments, the merchant can explicitly set which products/services and the circumstances under which a product would qualify for a rebate. In some embodiments, the private web UI can be simplified so the configuration can apply to all products/services. FIG. 4 shows an example of a UI where the merchant can enter a percentage of the sale transaction that would be returned to the customer as a rebate. The upper limit can also be set a dollar amount. In some embodiments, the rebate program rules are stored on database 304 on rebate computer 303.

Based on the rebate program configuration, after each purchase at 201, rebate computer 303 determines if the purchase qualifies for a post-sale incentivized action based on the rebate program rules stored on database 304. In some embodiments, the purchase data (transaction amount, item purchased, etc.) and the rebate configuration data will be used to compute the eligibility of the rebate program. In some other embodiments, the system can use data pulled from a customer relationship management system (CRM) 305, for example, the purchasing history of the customer and/or other data typically used in loyalty programs. For example, the historical purchase history for the customer can be used to implement a rebate rule as follows: “If the customer made purchases worth over $100 in the last 2 months, then they qualify for a rebate offer”.

After each purchase at 201, if the customer qualifies for a rebate offer at 202, then the rebate system will solicit a post-sale action from the customer which will be incentivized by a rebate offer at 203.

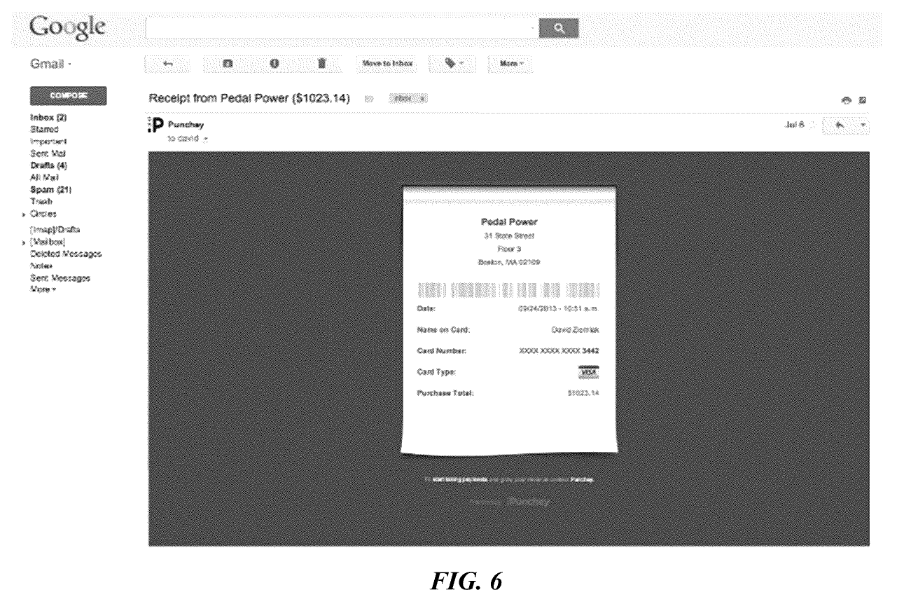

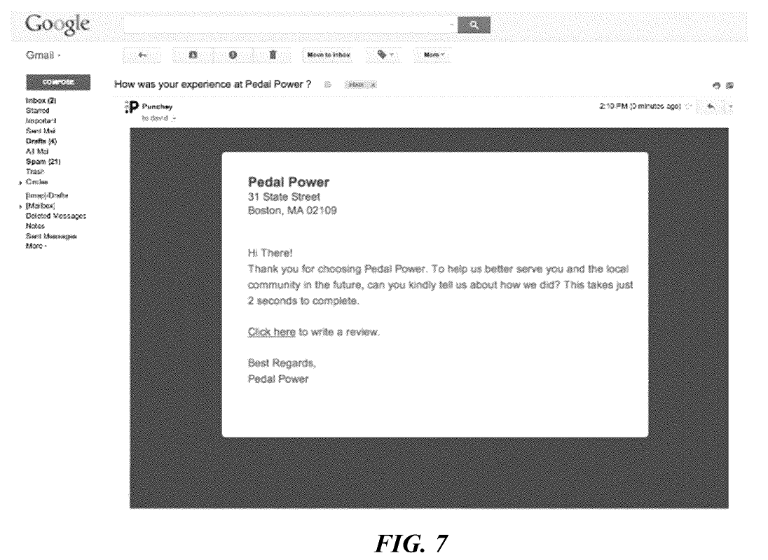

In some embodiments, post-sale action solicitation methods include sending an email and/or a SMS text message via some third party service providers at 306. The email/message will typically include a URL with a unique identifier that is associated with the customer's purchase and payment transaction (e.g., as illustrated in FIG. 6). In other embodiments, the URL or its equivalent QR code will be printed on the customer receipt together with a brief description of the rebate offer (e.g., as illustrated in FIG. 7).

In many embodiments, post-sale actions for the client at 310 include: post a review on a search engine, post a review on an online directory, post a review on the merchant's business website, take an online survey and/or submit a feedback form, create an online user account on online system or sign up for membership in program in program controlled by the merchant, send referral to the merchant's business, create a social media post that contains a certain hashtag, etc.

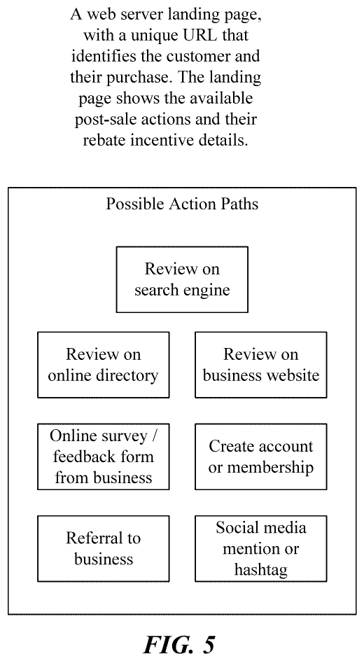

The rebate system includes a public web interface at 307, hosted on the rebate web server 301. The rebate web server hosts a landing page. When a user visits the landing page via the provided unique URL, the rebate system identifies the user as the customer that did the purchase, and the user will be presented with one or more post-sale actions and their corresponding rebate incentives. FIG. 5 shows an example of such a landing page. In the landing page or in the subsequent page after they select the post-sale action, the user will also be able to add additional personal information that would help in identifying and verifying their post-sale action. For example, if the post-sale action is to do a review of the business' product/service on a search engine, then the user can add information that includes their account username on the search engine and/or the URL to the review itself. Similarly, if the post-sale action is to do a post on a social media page, then they can enter their social media user handle and the URL to the post they did.

In some embodiments, the merchant may be able to manually verify that the client took the post-sale action, for example by seeing the client's post or review on social media at 312. The merchant will also be able to use the rebate webserver and its interface at 302 (either directly or through an API) and update the records for the customer. They can manually update the records to show that indeed the customer took the post-sale action (offline verification at 312) and the customer is now eligible for the rebate payment.

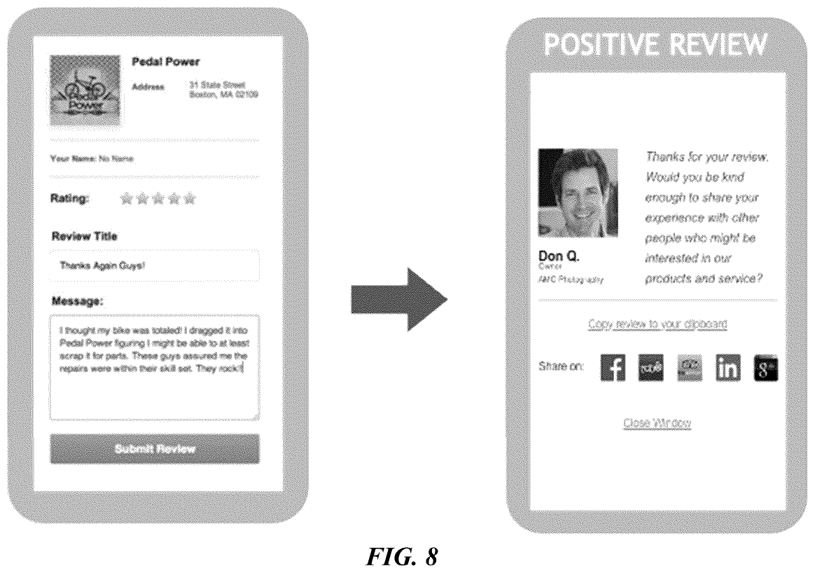

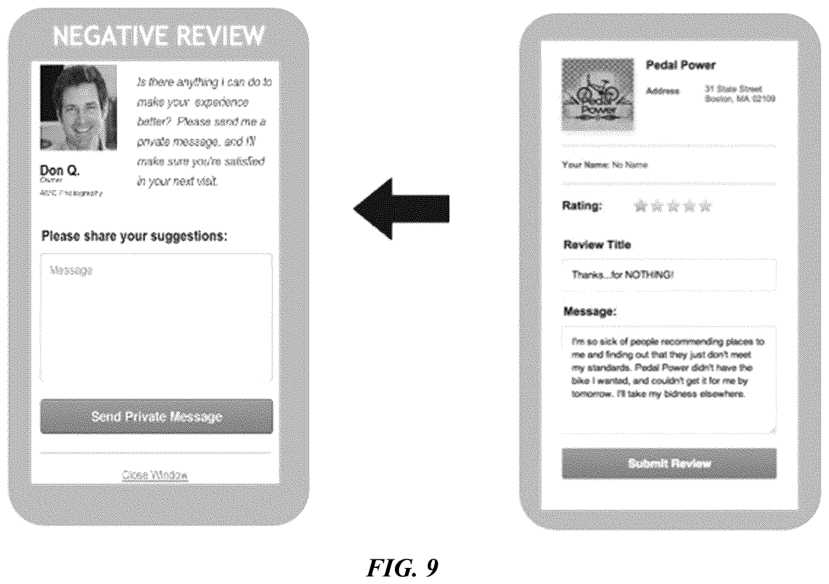

In addition to the merchant manually verifying the post-sale action, in many embodiments, the rebate system, via various methods can determine if the post-sale action was indeed taken. In many embodiments, the rebate system will use the data entered by the customer (social media user handle, post/review URL) and by using APIs and/or screen scraping/web-crawler techniques at 308 to determine whether the customer did indeed take the post-sale action. In other embodiments, where for example the post-sale action is to submit a feedback web form, see FIGS. 8-9, the web form can be implemented in such a way that a webhook at 309 is called upon submission of the form. In some embodiments, a webhook at 309 is a specially implemented URL endpoint on rebate web server 301, designed in such a way that it identifies the original transaction associated with the customer and their purchase. When the webhook is called from the feedback webform implementation it updates the rebate servers records to show that indeed the customer took the post-sale action.

Once the rebate computer determines that the post-sale action was taken for a given rebate offer, the rebate computer instructs the payment system at 311 to apply the rebate. The rebate amount will be returned via the same electronic form of tender as the original transaction of the purchase.

In some embodiments, the original transaction may be via ACH and so the rebate amount will also be transferred via ACH. ACH payments are usually not real time. They are usually processed in batches once or twice daily. In certain cases, the user may be able to take the solicited post-sale action before the ACH transfer of the original transaction is processed. In those cases, the system will update the ACH transfer of the original transaction to be the net value of the original amount and the rebate amount. In some embodiments, the rebate amount is returned via the same payment method used for the original transaction (e.g., card number or bank account). In other embodiments, the rebate amount is returned via another payment method that is different from a payment method used for the original transaction. For example, the other payment method can be store credit, a digital wallet, and/or other account that is registered with a person corresponding to the original transaction. In some embodiments, the rebate amount is dynamic such that it is a percentage of a purchase price and/or a flat amount for different items. In such embodiments, the rebate amount can be a sliding scale that, for example, increases or decreases as more rebates are used. For example, the percentage can be 2% for small transactions and 5% for large transactions. In some embodiments, the rebate amount is static such that it is a flat amount for all items. The following is an example of such a case. A client agrees to pay via ACH $100 for a service provided by the merchant. The rebate system determines that the client is eligible for a rebate and automatically solicits via an SMS text a review post and offers in return a $20 rebate. Then the client takes the solicited post-sale soon after they receive the SMS text. If the original ACH transaction for $100 has not been processed yet, then the system updates the amount to be the net value of original amount ($100) and the rebate amount ($20) which is $80. If however, the client does not take the solicited post-sale action until the next day, the original transaction of $100 will already be processed, and in that case a new return ACH transaction will be initiated by the rebate system for $20.

In other embodiments, the original transaction will be done via a Credit/Debit card. The authorization step of the Debit/Credit card transaction is real time. However, the settlement step is usually done once a day and is typically done at the end of the business day. Similar to the ACH case, this allows for the rebate system to adjust the transaction amount if the client took the solicited post-sale action before the settlement time. In some embodiments, the adjustment is dynamic such that it is a percentage of a purchase price and/or a flat amount for different items. In such embodiments, the adjustment can be a sliding scale that, for example, increases or decreases as more rebates are used. For example, the percentage can be 2% for small transactions and 5% for large transactions. In some embodiments, the rebate amount is static such that it is a flat amount for all items. An equivalent example to the ACH case would be as follows. A client uses their credit card to make a purchase of a service for $100. The credit card authorization happens in real time. The client receives the rebate offer in an SMS text message and they take the solicited post-sale action right away. All this can happen only minutes after the credit card payment. Since the client took the solicited action before the settlement time, the rebate system can issue a partial reversal of the original transaction for $20 (rebate amount). So at the time of settlement the transaction amount will be the original amount net of the rebate amount, i.e. $80. So effectively, the client does not get charged the full amount. If however, the client takes the solicited post-sale action the next day, i.e. after the settlement time, then the rebate system will instruct the payment system to issue a partial refund of $20.

In some embodiments, the immediate nature of the rebate offer will result in higher rates of clients complying with the post-sale action solicitations. Since the client is more likely to receive the rebate, they are also more likely to make the purchase.

FIG. 10 is a flow diagram illustrating a method (e.g., method 1000) for incentivizing post-sale actions in accordance with some embodiments. Some operations in method 1000 are, optionally, combined, the orders of some operations are, optionally, changed, and some operations are, optionally, omitted.

As described below, method 1000 provides an intuitive way for incentivizing post-sale actions. Method 1000 reduces the cognitive burden on a user, thereby creating a more efficient human-machine interface. For battery-operated computing devices, enabling a user to interact with such devices faster and more efficiently conserves power and increases the time between battery charges.

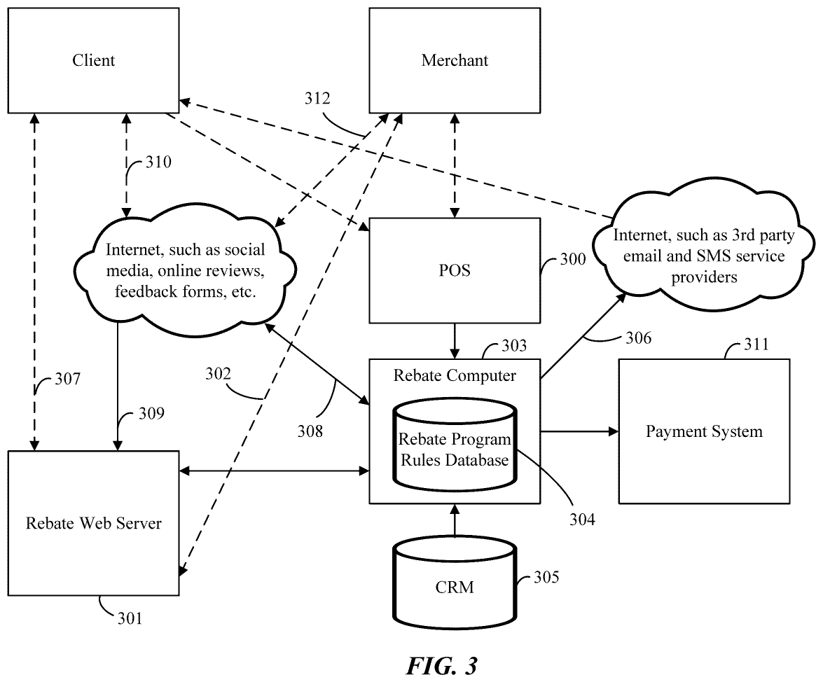

In some embodiments, method 1000 is performed at a computer system (e.g., 100, client in FIG. 3, merchant in FIGS. 3, 300, 301, 303, and/or 311). In some embodiments, the computer system is a payment system, a payment authorization gateway, and/or a server.

The computer system receives (1002) (e.g., 302, 309, and/or communication from POS 300 to rebate computer 303) an indication of a first review corresponding to a first transaction. It should be recognized that a first is one example of a post-sale action and that other types of post-sale actions can be used with techniques described herein, such as a referral, a repost, a mention, and/or a survey. In some embodiments, the indication includes an identifier (e.g., a Uniform Resource Identifier (URI), a Uniform Resource Locator (URL), a title, and/or a unique identifier such as a universal unique identified (UUID)). In some embodiments, the first review corresponds to a first product and/or a first service that was purchased via the first transaction. In some embodiments, the first transaction is processed via the computer system. In some embodiments, the first transaction is processed via another computer system different from the computer system. In some embodiments, the indication of the first review is received after the first transaction is processed.

After (1004) (and/or in response to) receiving the indication of the first review corresponding to the first transaction, in accordance with a determination that the first review satisfies a first set of one or more criteria (e.g., 202 and/or 204), the computer system provides (1006) (e.g., communication from rebate computer 303 to payment system 311), to an account (e.g., a debit or credit account, an account with a merchant corresponding to the first transaction, and/or an account used to pay for the first transaction) corresponding to the first transaction, a first amount of value (e.g., an incentive, a rebate, an amount of money, and/or a discount). In some embodiments, the first amount of value is based on an amount of the first product, the first service, and/or the first transaction. In some embodiments, the first amount of value is automatically provides without detecting user input (e.g., via an input device that is in communication with the computer system) corresponding to a request to provide the first amount of value.

After (1004) receiving the indication of the first review corresponding to the first transaction, in accordance with a determination that the first review does not satisfy the first set of one or more criteria, the computer system forgoes (1008) providing, to the account corresponding to the first transaction, the first amount of value.

In some embodiments, the first review is a customer review (e.g., as illustrated in FIGS. 5, 8, and 9). In some embodiments, the first review is an online review (e.g., as illustrated in FIGS. 5, 8, and 9). In some embodiments, the first review is on a search engine (e.g., as illustrated in FIG. 5). In some embodiments, the first review is on an online directory (e.g., as illustrated in FIG. 5). In some embodiments, the first review is on a website of a merchant corresponding to the first transaction (e.g., as illustrated in FIGS. 5, 8, and 9). In some embodiments, the first review is on a social media platform (e.g., as illustrated in FIG. 5). In some embodiments, the first review is performed via near-field communication (NFC) (e.g., a customer uses NFC to receive a form for filling out a review) or a Quick Response (QR) code (e.g., a customer uses a phone to scan the QR code to receive a form for filling out a review).

In some embodiments, the indication includes an identification of a username different from the account. In some embodiments, the indication is received via a webhook. In some embodiments, the indication includes an identification of a Uniform Resource Locator (URL). In some embodiments, the URL corresponds to a location of the first review. In some embodiments, the indication of the first review is received from a merchant device (e.g., merchant in FIG. 3).

In some embodiments, the computer system includes an input device (e.g., a microphone, a hardware input mechanism, a rotatable input mechanism, a physical input mechanism, a button, a crown, a knob, a dial, a physical slider, an accelerometer, a mouse, a keyboard, a touchpad, and/or a touch-sensitive surface). In some embodiments, receiving the indication of the first review includes detecting, via the input device, a user input confirming that the first review has been completed. In some embodiments, the input device is a mouse, a keyboard, a touch-sensitive surface, or a combination thereof.

In some embodiments, the first transaction is performed via a physical point-of-sale device (e.g., POS 300). In some embodiments, the first transaction is performed via an online store. In some embodiments, the first transaction was completed via an electronic form of tender (e.g., 201 and/or as illustrated in FIG. 6). In some embodiments, the account is the electronic form of tender. In some embodiments, the first amount of value is provided via a payment system (e.g., 311). In some embodiments, the first amount of value is a rebate to the first transaction.

In some embodiments, the first set of one or more criteria includes a criterion that is satisfied when the first transaction has been completed (e.g., pending payment and/or after payment). In some embodiments, the criterion is not satisfied when the first transaction has not been completed (e.g., pending payment and/or before payment has been submitted). In some embodiments, the first set of one or more criteria includes a criterion that is satisfied when the first review was completed within a predetermined period of time (e.g., 0-10 days) of the first transaction (e.g., 204). In some embodiments, the criterion is not satisfied when the first review was completed more than the predetermined period of time ago since the first transaction. In some embodiments, the first set of one or more criteria includes a criterion that is satisfied based on an amount of the first transaction (e.g., 202). In some embodiments, the criterion is satisfied when the amount of the first transaction exceeds a threshold (e.g., $20-100). In some embodiments, the criterion is not satisfied when the amount of the first transaction does not exceed the threshold. In some embodiments, the first set of one or more criteria includes a criterion that is satisfied based on an amount of value (e.g., a price before or after taxes, a sales prices, and/or a paid price) of an item (e.g., a product and/or a service) in the first transaction (e.g., 202). In some embodiments, the criterion is satisfied when the amount of value of the item exceeds a threshold (e.g., $5-100). In some embodiments, the criterion is not satisfied when the amount of value of the item does not exceed the threshold. In some embodiments, the first set of one or more criteria includes a criterion that is satisfied based on a record in a customer relationship management system (e.g., 305). In some embodiments, the criterion is satisfied when the record in the customer relationship management system matches an identity corresponding to the first transaction. In some embodiments, the criterion is not satisfied when no record in the customer relationship management system matches an identity corresponding to the first transaction. In some embodiments, the criterion is satisfied when the record in the customer relationship management system has a first purchase history. In some embodiments, the criterion is satisfied when the record in the customer relationship management system has a second purchase history different from the first purchase history. In some embodiments, the criterion is satisfied when the record in the customer relationship management system has a first configuration. In some embodiments, the criterion is satisfied when the record in the customer relationship management system has a second configuration different from the first configuration. In some embodiments, the first set of one or more criteria includes a criterion that is satisfied based on a purchase history of a customer corresponding to the first transaction. In some embodiments, the computer system receives, from a merchant device different from the computer system, a configuration (e.g., as illustrated in FIG. 4) of an amount for a product, a service, or a combination thereof, wherein the first set of one or more criteria includes a criterion that is satisfied when the first transaction corresponds to (and/or includes) the product, the service, or a combination thereof. In some embodiments, the amount is a percentage. In some embodiments, the amount is the first amount of value. In some embodiments, after receiving the indication of the first review corresponding to the first transaction, the computer system obtains proof that the first review has been completed, wherein the first set of one or more criteria includes a criterion that is satisfied based on the proof that the first review has been completed (e.g., 204). In some embodiments, the criterion is not satisfied when no proof is identified for the first review.

In some embodiments, providing the first amount of value includes reducing an amount (e.g., a price and/or an amount charged) of the first transaction. In some embodiments, providing the first amount of value includes providing a refund of at least a portion of an amount (e.g., a price and/or an amount charged) corresponding to the first transaction.

In some embodiments, the computer system includes a payment system (e.g., 311) or payment authorization gateway.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
at a computer system:
receiving an indication of a first review corresponding to a first transaction; and
after receiving the indication of the first review corresponding to the first transaction:
in accordance with a determination that the first review satisfies a first set of one or more criteria, providing, to an account corresponding to the first transaction, a first amount of value; and
in accordance with a determination that the first review does not satisfy the first set of one or more criteria, forgoing providing, to the account corresponding to the first transaction, the first amount of value.

2. The method of claim 1, wherein the first review is a customer review.

3. The method of claim 1, wherein the first review is an online review.

4. The method of claim 1, wherein the first review is on a search engine.

5. The method of claim 1, wherein the first review is on an online directory.

6. The method of claim 1, wherein the first review is on a website of a merchant corresponding to the first transaction.

7. The method of claim 1, wherein the first review is on a social media platform.

8. The method of claim 1, wherein the first review is performed via near-field communication (NFC) or a Quick Response (QR) code.

9. The method of claim 1, wherein the indication includes an identification of a username different from the account.

10. The method of claim 1, wherein the indication is received via a webhook.

11. The method of claim 1, wherein the indication includes an identification of a Uniform Resource Locator (URL).

12. The method of claim 11, wherein the URL corresponds to a location of the first review.

13. The method of claim 1, wherein the indication of the first review is received from a merchant device.

14. The method of claim 1, wherein the computer system includes an input device, and wherein receiving the indication of the first review includes detecting, via the input device, a user input confirming that the first review has been completed.

15. The method of claim 14, wherein the input device is a mouse, a keyboard, a touch-sensitive surface, or a combination thereof.

16. The method of claim 1, wherein the first transaction is performed via a physical point-of-sale device.

17. The method of claim 1, wherein the first transaction is performed via an online store.

18. The method of claim 1, wherein the first transaction was completed via an electronic form of tender.

19. The method of claim 18, wherein the account is the electronic form of tender.

20. The method of claim 1, wherein the first amount of value is provided via a payment system.

21. The method of claim 1, wherein the first amount of value is a rebate to the first transaction.

22. The method of claim 1, wherein the first set of one or more criteria includes a criterion that is satisfied when the first transaction has been completed.

23. The method of claim 1, wherein the first set of one or more criteria includes a criterion that is satisfied when the first review was completed within a predetermined period of time of the first transaction.

24. The method of claim 1, wherein the first set of one or more criteria includes a criterion that is satisfied based on an amount of the first transaction.

25. The method of claim 1, wherein the first set of one or more criteria includes a criterion that is satisfied based on an amount of value of an item in the first transaction.

26. The method of claim 1, wherein the first set of one or more criteria includes a criterion that is satisfied based on a record in a customer relationship management system.

27. The method of claim 1, wherein the first set of one or more criteria includes a criterion that is satisfied based on a purchase history of a customer corresponding to the first transaction.

28. The method of claim 1, further comprising:
receiving, from a merchant device different from the computer system, a configuration of an amount for a product, a service, or a combination thereof, wherein the first set of one or more criteria includes a criterion that is satisfied when the first transaction corresponds to the product, the service, or a combination thereof.

29. The method of claim 28, wherein the amount is a percentage.

30. The method of claim 29, wherein the amount is the first amount of value.

31. The method of claim 1, further comprising:
after receiving the indication of the first review corresponding to the first transaction, obtaining proof that the first review has been completed, wherein the first set of one or more criteria includes a criterion that is satisfied based on the proof that the first review has been completed.

32. The method of claim 1, wherein providing the first amount of value includes reducing an amount of the first transaction.

33. The method of claim 1, wherein providing the first amount of value includes providing a refund of at least a portion of an amount corresponding to the first transaction.

34. The method of claim 1, wherein the computer system includes a payment system or payment authorization gateway.

35. A non-transitory computer-readable storage medium storing one or more programs configured to be executed by one or more processors of a computer system, the one or more programs including instructions for:
receiving an indication of a first review corresponding to a first transaction; and
after receiving the indication of the first review corresponding to the first transaction:
in accordance with a determination that the first review satisfies a first set of one or more criteria, providing, to an account corresponding to the first transaction, a first amount of value; and
in accordance with a determination that the first review does not satisfy the first set of one or more criteria, forgoing providing, to the account corresponding to the first transaction, the first amount of value.

36. A computer system, comprising:
one or more processors; and
memory storing one or more programs configured to be executed by the one or more processors, the one or more programs including instructions for:
receiving an indication of a first review corresponding to a first transaction; and
after receiving the indication of the first review corresponding to the first transaction:
in accordance with a determination that the first review satisfies a first set of one or more criteria, providing, to an account corresponding to the first transaction, a first amount of value; and
in accordance with a determination that the first review does not satisfy the first set of one or more criteria, forgoing providing, to the account corresponding to the first transaction, the first amount of value.
